(19) United States
(12) Patent Application Publication
(10) Pub. No.: US 2008/0207125 A1
(43) Pub. Date: Aug. 28, 2008

(54) Method and Apparatus to Facilitate Conforming a Wireless Personal Communications Device to a Local Social Standard

(75) Inventors: Yuan-Jun Wei, Hoffman Estates, IL (US); Steven W. Albrecht, Glenview, IL (US); Changxue C. Ma, Barrington, IL (US)

Correspondence Address: FITCH EVEN TABIN AND FLANNERY, 120 SOUTH LA SALLE STREET, SUITE 1600, CHICAGO, IL, 60603-3406, US

(73) Assignee: MOTOROLA, INC., Schaumburg, IL (US)

(21) Appl. No.: 11/679,704

(22) Filed: Feb. 27, 2007

(51) Int. Cl. H04B 7/00; H04B 7/24; H04M 1/00

(52) U.S. Cl. 455/41.2; 455/39; 455/550.1

(57) ABSTRACT

A wireless transmitter (201) transmits (102) a message intended for at least one wireless personal communications device (202). That message comprises content (203) configured and arranged to at least attempt to prompt a particular operability configuration for the wireless personal communications device that conforms to social standards as correspond to a given local venue (204). Such content can vary with the application setting with some relevant examples comprising, but not being limited to, information indicative of a degree to which the operability configuration comprises a required operability configuration (as versus a voluntary or merely suggested configuration), information indicative of at least one particular capability of the wireless personal communication device to which the operability configuration pertains, and/or information corresponding to a time frame during which the operability configuration is applicable, to note but a few.

### TECHNICAL FIELD

This invention relates generally to wireless personal communications devices.

### BACKGROUND

Wireless personal communications devices of various kinds are known in the art and include, but are not limited to, various cellular telephones, two-way text and graphics messaging platforms, and so forth. The absolute number of such devices in use continues to grow precipitously as does the functionality and capability of such devices. For example, some such devices provide highly personalized audible incoming call annunciations while other such devices are able to serve as portable speaker phone platforms that render incoming audio content perceptible by persons within the general local area of the device. As another example, some such devices have an illuminated display capable of rendering a wide variety of static and dynamic visual content.

Many such devices are also increasingly able to support functionality that is only partially related, or even unrelated, to wireless communications as such. For example, many such devices are able to function as a still image or video capture device. As another example, many such devices are able to function as a game platform.

Unfortunately, there are application settings where unfettered use of such capabilities and functionality can disturb local social standards. As one simple example in this regard, the use of such a device to carry on a conversation during a theatrical presentation can be annoying to other members of the audience. As another example in this regard, sounding an incoming call alert (and perhaps especially when using a ringtone comprising an inappropriately loud and/or distinct musical rendering) during a live orchestral presentation can be similarly annoying.

There are also settings where inappropriate usage of such a device can pose an operational threat or otherwise constitute a violation of application laws or regulations. Use of certain features such as image capture capabilities in a restricted setting, for example, may constitute a violation of application law. As another example in this regard, use of the two-way wireless capabilities of such a device during a commercial flight in the United States may violate the carrier's rules and may even constitute a violation of applicable law at some time in the future.

At present, the user of such a device remains largely responsible for being both cognizant of such social standards and observing such standards in an appropriate manner. For a variety of reasons, however, such an approach often proves insufficient. Instead, such devices are often used inappropriately in a manner that annoys and/or endangers others and/or that exposes the user to criticism, liability, or worse.

### BRIEF DESCRIPTION OF THE DRAWINGS

The above needs are at least partially met through provision of the method and apparatus to facilitate conforming a wireless personal communications device to a local social standard described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a flow diagram as configured in accordance with various embodiments of the invention; and

FIG. 5 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a wireless transmitter transmits a message intended for at least one wireless personal communications device. That message comprises content configured and arranged to at least attempt to prompt a particular operability configuration for the wireless personal communications device that conforms to social standards as correspond to a given local venue. Such content can vary with the application setting with some relevant examples comprising, but not being limited to, information indicative of a degree to which the operability configuration comprises a required operability configuration (as versus a voluntary or merely suggested configuration), information indicative of at least one particular capability of the wireless personal communication device to which the operability configuration pertains, and/or information corresponding to a time frame during which the operability configuration is applicable, to note but a few.

By one approach the aforementioned transmission can comprise a relatively short range wireless transmission. The aforementioned content can further comprise, as desired, any one or more of information regarding a time at which the operability configuration becomes applicable, information regarding identification of the given local venue, information regarding future transmissions regarding the content, and/or information suitable for use by the wireless personal communications device to determine directional movement with respect to other transmissions of similar, but different content (to thereby aid in avoiding confusion and error when receiving multiple such messages as correspond to a plurality of closely located local venues).

By one approach, such a message can be rendered perceivable to a user of such a wireless personal communications device. This might comprise, for example, alerting the user to receipt of such a message and providing information regarding that content using a display as comprises a part of that device. In such a case, if desired, the user may indicate a desire to essentially ignore the proscribed social standard. These teachings will also then optionally accommodate automatically ignoring future such messages so as to not burden the user with repeated notices that will also be ignored by that user.

So configured, these teachings provide an effective way to leverage numerous available technologies to effect an economical and reliable mechanism for ensuring that a user of a wireless personal communications device becomes at least informed of a relevant and applicable social standard as pertains to the configuration and use of that wireless personal communications device. Those skilled in the art will recognize and appreciate that these teachings are also readily scaled to accommodate essentially any number of local venues, social standards, and/or wireless personal communication devices.

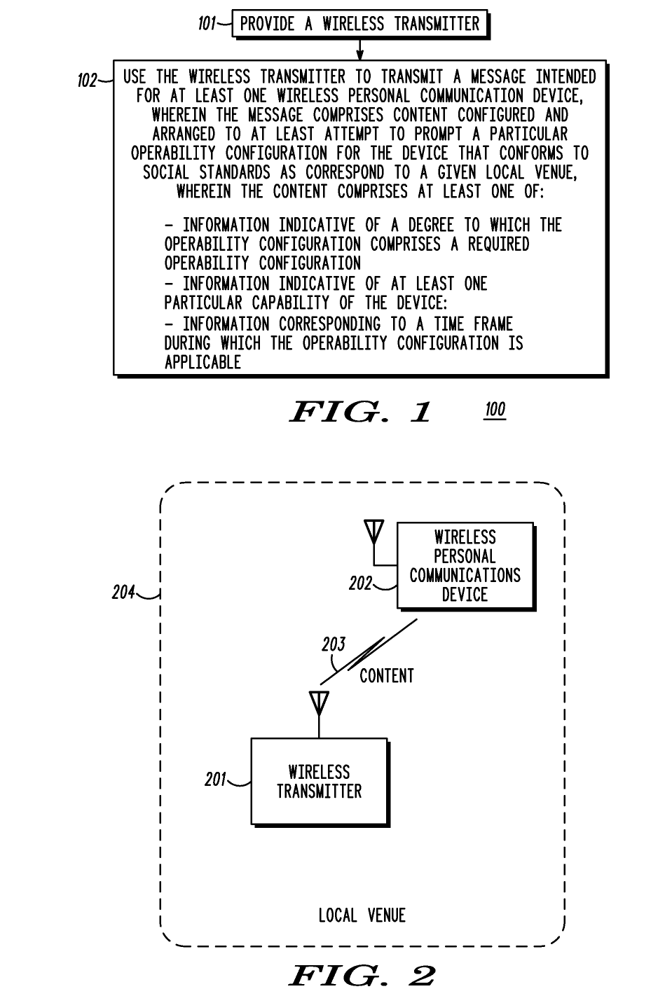

These and other benefits may become clearer upon making a thorough review and study of the following detailed description. Referring now to the drawings, and in particular to FIGS. 1 and 2, these teachings will support the use of a process 100 that provides, in turn, for provision 101 of a wireless transmitter 201. There are various transmitters that will suffice for these purposes. For at least many application settings of interest, this wireless transmitter 201 can comprise a short range wireless transmitter (i.e., a transmitter that is configured and arranged to only transmit a useful signal within a relatively small coverage area such as a few feet or a few yards). There are various known technologies available to meet such a need (such as, but not limited to, Blue Tooth compliant transmitters, certain 802.11-family compliant transmitters, transmitters using so-called wireless microphone bearer frequencies, and so forth).

For many other application settings, a longer range wireless transmitter can be utilized for these same purposes. As but one illustrative example of many possibilities, a so-called WiMax transmitter could serve to transmit a signal for many miles on behalf of a local venue comprising a public place such as a particular municipality regarding a local social standard about not using mobile telephones while driving an automobile except in a hands-free mode of operation.

As the present teachings are not particularly sensitive to the selection of any particular approach or technology in this regard, for the sake of brevity further elaboration in this regard will not be provided here.

This process 100 then provides for using 102 this wireless transmitter 201 to transmit a message that comprises content 203 intended for at least one wireless personal communications device 202. By one approach, this content 203 is configured and arranged to at least attempt to prompt a particular operability configuration for the wireless personal communications device 202 that conforms to social standards as correspond to a given local venue 204. The local venue 204 can comprise essentially any venue of choice. Some representative examples might include, but are certainly not limited to, retail establishments, motion picture and live presentation theaters, medical services areas, commercial aircraft cabins, and so forth. As noted above, the wireless transmitter 201 can comprise a short range platform. In many cases this limited coverage range will nevertheless well accommodate the footprint of the local venue 204. In cases where the local venue 204 represents an area larger than that which can be reasonably accommodated by the effective coverage zone of the wireless transmitter 201, a plurality of such wireless transmitters can serve in this regard as will be well understood by those skilled in the art.

The specific nature of the aforementioned content can vary with the requirements and/or opportunities as tend to characterize a given application setting. For many purposes, however, this content can comprise at least one of:

Information indicative of a degree to which the operability configuration comprises a required operability configuration (for example, a simple binary value could serve to indicate whether the operability configuration is mandatory or voluntary while a two bit value could serve to indicate whether the operability configuration is: (a) required for all recipients, (b) required for only a specific class of recipients, (c) voluntary but highly suggested, or (d) voluntary and only politely requested, with numerous other examples of course being possible);

Information indicative of at least one particular capability of the wireless personal communication device to which the operability configuration pertains (such as, but not limited to, ringtone type, usage, volume, or duration, two-way communications capability, one-way communications capability, speakerphone capability, audio transducer and/or playback capability, illuminated display capability, image capture capability, audio recording capability, and so forth);

Information corresponding to a time frame during which the operability configuration is applicable (including, for example, an indication of any one or more of a present time, a scheduled start time (which might comprise, for example, information regarding a time at which the operability configuration becomes applicable), a minimum period of observance, a maximum period of observance, a scheduled end time (which might comprise, for example, a time at which the operability configuration becomes non-applicable), and so forth);

Information regarding identification of the given local venue 204 (such as, but not limited to, an identifying alphanumeric string or alias, an identifying number or other address or the like, geographic coordinates (such as longitude and latitude coordinates, a street address, or the like), information that specifically identifies the particular local venue 204, information that generally identifies the particular local venue 204 (such as information that characterizes the kind and/or purpose of the local venue), and so forth);

Information regarding future transmissions regarding the content; and/or

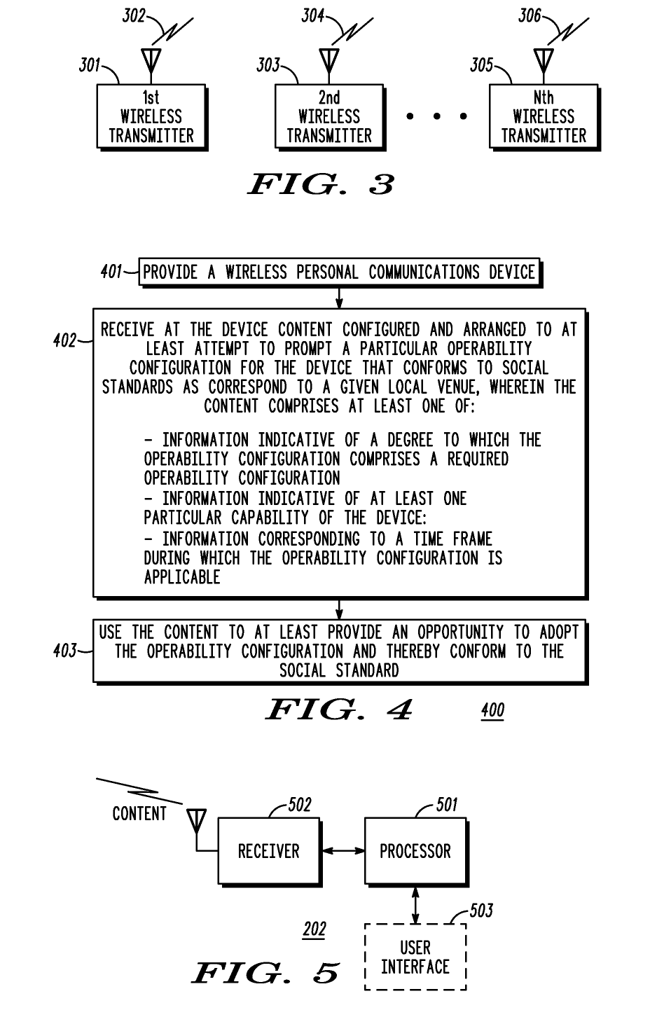

Information suitable for use by the wireless personal communications device 202 to determine direction movement with respect to other transmissions of similar, but different, content (as may be useful in an area that is relatively densely populated by a plurality of nearby, adjacent, or even overlapping local venues as may occur, for example, in a shopping mall), where such information might be provided, for example, by a plurality of wireless transmitters 301, 305, and 305 (as shown in FIG. 3) and may consist of corresponding content 302, 304, and 306 that, when received and processed by a wireless personal communications device 202 can be readily processed to determine a direction of movement with respect to such wireless transmitters and hence with respect to the corresponding local venue to thereby inform a decision regarding whether to observe or ignore the aforementioned content regarding the operability configuration);

to note but a few examples in this regard.

As suggested above, such content can comprise one, two, three, or more of the above suggested informational components as desired and/or as may be required or possible in a given application setting. In some cases this step of using the wireless transmitter 201 to transmit such content can comprise operating the wireless transmitter 201 as a beacon. In such a case the wireless transmitter 201 simply transmits such information in a substantially continuous or intermittent manner to whatever wireless personal communications devices may be present. By another approach, this wireless transmitter 201 may be configured and arranged to transmit such content in response to receiving a transmission from the wireless personal communications device. Such a transmission from the wireless personal communications device may itself comprise a probe, handshake, or other invitation message as may be transmitted from time to time by the wireless personal communications device pursuant to its own configuration and operability.

Other possibilities are available as well, of course. Those skilled in the art will recognize and understand that the transmission of such content by the wireless transmitter 201 can be rendered responsive to, for example, the opening of a door that serves as an entrance to the local venue 204, an infrared or ultrasound-based user proximity detector, a weight-based sensor, and so forth.

Wireless transmitters of various kinds are well known in the art. As the present teachings are not particularly sensitive to the selection of any particular approach in this regard, for the sake of brevity further elaboration regarding such wireless transmitters will not be provided here.

With reference now to FIG. 4, an illustrative corresponding process 400 that can be usefully employed by the wireless personal communications device 202 can comprise, following provision 401 of the wireless personal communications device itself, receiving 402 the aforementioned content that is configured and arranged to at least attempt to prompt a particular operability configuration for the wireless personal communications device 202 that conforms to social standards as correspond to the aforementioned given local venue 204. This may comprise, as noted above, receiving a relatively short range transmission and may, in many application settings, comprise receiving the content via a bearer channel (such as, but not limited to, a channel employing a Bluetooth frequency and protocol) that is different than the bearer medium that the device ordinarily uses to effect its longer range communications needs.

The wireless personal communications device 202 can then use 403 that content to at least provide an opportunity to adopt the operability configuration and thereby conform the applicable social standard. By one approach, this can comprise, for example, notifying a user of the wireless personal communications device 202 regarding the proposed operability configuration and then receiving from that user information regarding use and adoption of that operability configuration to thereby conform to the social standard. There are various ways by which this notice and instruction-receipt functionality can be accomplished. Such a notice can be provided (with or without a corresponding audible or haptic annunciation) via a display of choice as may comprise a part of the device's user interface. The receipt of the user's instructions, in turn, can be similarly received via an appropriate corresponding user interface (such as via a touch screen display, a keypad or cursor control mechanism, voice recognition, and so forth).

When pursuing such an approach, it is possible that a given user will chose to effectively ignore adopting the operability configuration (and the corresponding social standard). This may be appropriate for any number of reasons to ensure that important and/or critical platform functionality remains unfettered and uncompromised notwithstanding the social standard at issue. In such a case, it may be appropriate for this step of using 403 the content to further provide for automatically not notifying such a user of at least some (and perhaps all) subsequently received messages (from this or other wireless transmitters) that contain content similar or identical to the refused content. By this approach, when a given user refuses to accede to a proposed operability configuration, the wireless personal communications device 202 can then automatically determine to effectively ignore subsequently received similar suggestions on behalf of this user. If desired, such an approach can be limited to use with only subsequently received messages from a same wireless transmitter. By another approach, such an approach can be extended to include similar messages from other wireless transmitters as might be received, for example, within some predetermined period of time (which may be automatically determined or, for example, specifically entered or selected by the user).

In the above examples, adopting or refusing to adopt the operability configuration lies with the user of the device. By another approach, however, if desired the wireless personal communications device 202 itself can automatically make such a determination. By this approach, for example, the wireless personal communications device 202 may automatically adopt a received operability configuration to thereby facilitate automatically conforming to the corresponding social standard. Such behavior may be pre-programmed by the user, if desired, to reflect the user's preferences in this regard. It would also be possible to combine these two general approaches to permit voluntary user-based decisions in some instances while mandating device-based decisions in other use cases.

Those skilled in the art will appreciate that the above-described processes are readily enabled using any of a wide variety of available and/or readily configured wireless personal communications device platforms, including partially or wholly programmable platforms as are known in the art or dedicated purpose platforms as may be desired for some applications. Referring now to FIG. 5, an illustrative approach to such a platform will now be provided.

As illustrated, the wireless personal communications device 202 (which might itself comprise, for example, a cellular telephone or the like) can comprise a processor 501 that operably couples to a receiver 502 and optionally to a user interface 503 of choice. The receiver 502 (which can comprise, as suggested above, a short range transmission medium receiver) can be configured and arranged to receive the aforementioned content 203 and to thereby facilitate compatible receipt and processing of such content by the processor 501. The latter, in turn, can be configured and arranged to use this content 203 to at least provide the aforementioned opportunity to adopt the operability configuration and thereby conform to the applicable social standard.

By one approach this can comprise, as desired, configuring and arranging the processor 501 to use the content 203 to automatically adopt the corresponding operability configuration and thereby automatically conform operation of the wireless personal communications device 202 to the corresponding social standard. By another approach (in lieu of or in combination with the automated approach) this can comprise, as desired, configuring and arranging the processor 501 to notify the user (via, for example, the user interface 503) regarding the suggested operability configuration and receiving (again via, for example, the user interface 503) user information regarding use of the suggested operability configuration.

Those skilled in the art will recognize and understand that such an apparatus 202 may be comprised of a plurality of physically distinct elements as is suggested by the illustration shown in FIG. 5. It is also possible, however, to view this illustration as comprising a logical view, in which case one or more of these elements can be enabled and realized via a shared platform. It will also be understood that such a shared platform may comprise a wholly or at least partially programmable platform as are known in the art and that, in such a case, the aforementioned configuration and arrangement of the processor 501 can be accomplished, at least in part, via programming as will be well understood by those skilled in the art.

So configured, these teachings will readily facilitate both informing the users and/or their devices of applicable operability configurations that, in turn, will aid the user/device with respect to remaining compliant and respectful of local social standards regarding the use of such devices. These teachings are highly leveragable and can be readily applied in conjunction with a wide range of social standards that vary both with respect to the nature of their manner of compliance and the relative importance of observing their dictates. Those skilled in the art will also recognize and appreciate that these teachings can be readily scaled to accommodate both relatively isolated and occasional usage up to relatively dense and frequently imposed operational conditions.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, these teachings will readily accommodate providing content that presents two or more optional operability configurations to thereby provide a given recipient with more than one way to comply, in whole or in part, with an applicable social standard.

We claim:

1. A method comprising:
providing a wireless transmitter;
using the wireless transmitter to transmit a message intended for at least one wireless personal communications device, wherein the message comprises content configured and arranged to at least attempt to prompt a particular operability configuration for the wireless personal communications device that conforms to social standards as correspond to a given local venue, wherein the content comprises, at least in part, at least one of:
information indicative of a degree to which the operability configuration comprises a required operability configuration;
information indicative of at least one particular capability of the wireless personal communication device to which the operability configuration pertains;
information corresponding to a time frame during which the operability configuration is applicable.

2. The method of claim 1 wherein providing a wireless transmitter comprises providing a short range wireless transmitter.

3. The method of claim 1 wherein using the wireless transmitter to transmit a message intended for at least one wireless personal communications device comprises, at least in part:
receiving a transmission from the wireless personal communications device;
transmitting the message in response to having received the transmission from the wireless personal communications device.

4. The method of claim 1 wherein the content comprises, at least in part, at least two of:
information indicative of a degree to which the operability configuration comprises a required operability configuration;
information indicative of at least one particular capability of the wireless personal communication device to which the operability configuration pertains;
information corresponding to a time frame during which the operability configuration is applicable.

5. The method of claim 1 wherein the content further comprises at least one of:
information regarding a time at which the operability configuration becomes applicable;
information regarding identification of the given local venue;
information regarding future transmissions regarding the content;
information suitable for use by the wireless personal communications device to determine directional movement with respect to other transmissions of similar, but different, content.

6. The method of claim 1 wherein the information corresponding to a time frame during which the operability configuration is applicable comprises, at least in part, at least one of:
an indication of a present time;
an indication of a time at which the operability configuration becomes applicable;
an indication of a time at which the operability configuration becomes non-applicable.

7. A wireless personal communications device comprising:
a receiver configured and arranged to receive content configured and arranged to at least attempt to prompt a particular operability configuration for the wireless personal communications device that conforms to social standards as correspond to a given local venue, wherein the content comprises, at least in part, at least one of:
information indicative of a degree to which the operability configuration comprises a required operability configuration;
information indicative of at least one particular capability of the wireless personal communication device to which the operability configuration pertains;
information corresponding to a time frame during which the operability configuration is applicable;
a processor operably coupled to the receiver and being configured and arranged to use the content to at least provide an opportunity to adopt the operability configuration and thereby conform to the social standard.

8. The wireless personal communications device of claim 7 wherein the wireless personal communications device comprises a cellular telephone.

9. The wireless personal communications device of claim 7 wherein the receiver comprises a short range transmission medium receiver.

10. The wireless personal communications device of claim 7 wherein the content comprises, at least in part, at least two of:
information indicative of a degree to which the operability configuration comprises a required operability configuration;
information indicative of at least one particular capability of the wireless personal communication device to which the operability configuration pertains;
information corresponding to a time frame during which the operability configuration is applicable.

11. The wireless personal communications device of claim 7 wherein the processor is further configured and arranged to use the content to automatically adopt the operability configuration and thereby automatically conform to the social standard.

12. The wireless personal communications device of claim 7 wherein the processor is further configured and arranged to:
notify a user of the wireless personal communications device regarding the operability configuration;
receive from the user information regarding using the operability configuration to thereby conform to the social standard.

13. The wireless personal communications device of claim 12 wherein the processor is further configured and arranged to:
upon receiving from the user information regarding not using the operability configuration, automatically not notifying the user of at least some subsequently received messages containing at least similar content to the content.

14. The wireless personal communications device of claim 7 wherein the processor is further configured and arranged to use the content to determine, at least in part, an appropriate response to a subsequently received message containing similar, but different, content.

15. A method comprising:
providing a wireless personal communications device;
receiving at the wireless personal communications device content configured and arranged to at least attempt to prompt a particular operability configuration for the wireless personal communications device that conforms to social standards as correspond to a given local venue, wherein the content comprises, at least in part, at least one of:
information indicative of a degree to which the operability configuration comprises a required operability configuration;
information indicative of at least one particular capability of the wireless personal communication device to which the operability configuration pertains;
information corresponding to a time frame during which the operability configuration is applicable;
at the wireless personal communications device, using the content to at least provide an opportunity to adopt the operability configuration and thereby conform to the social standard.

16. The method of claim 15 wherein receiving comprises receiving a short range transmission.

17. The method of claim 15 wherein the content comprises, at least in part, at least two of:
information indicative of a degree to which the operability configuration comprises a required operability configuration;
information indicative of at least one particular capability of the wireless personal communication device to which the operability configuration pertains;
information corresponding to a time frame during which the operability configuration is applicable.

18. The method of claim 15 wherein using the content comprises automatically adopting the operability configuration and thereby automatically conforming to the social standard.

19. The method of claim 15 wherein using the content further comprises:
notifying a user of the wireless personal communications device regarding the operability configuration;
receiving from the user information regarding using the operability configuration to thereby conform to the social standard.

20. The method of claim 19 wherein using the content further comprises:
upon receiving from the user information regarding not using the operability configuration, automatically not notifying the user of at least some subsequently received messages containing at least similar content to the content.
